(19) United States
(12) Patent Application Publication
(10) Pub. No.: US 2014/0244286 A1
(43) Pub. Date: Aug. 28, 2014

(54) INSURANCE COMPANY, PHARMACY BENEFITS MANAGERS, PHARMACIES, STATE AGENCIES, FEDERAL AGENCIES, AND QUALITY ASSURANCE REPORTING

(71) Applicant: Complete Consent, LLC, Savannah, GA (US)

(72) Inventor: Sidney P. Smith, Savannah, GA (US)

(73) Assignee: Complete Consent, LLC, Savannah, GA (US)

(21) Appl. No.: 14/189,371

(22) Filed: Feb. 25, 2014

Related U.S. Application Data
(60) Provisional application No. 61/768,622, filed on Feb. 25, 2013.

(51) Int. Cl. G06Q 50/22; G06Q 30/00

(52) U.S. Cl. CPC G06Q 50/22; G06Q 30/018; G06Q 40/08
USPC 705/2

(57) ABSTRACT

Quality assurance reporting enables efficient and concise reports of errors, omissions or deficiencies relating to medical claims and procedures. The system maintains a public record, establishes a communication platform for interested parties, and establishes time metrics for corrective action. A web page standardizes a format for parties to report the errors, omissions or deficiencies. A deficiency report is generated and delivered to a deficient party. The web page publicizes the deficiency report and notifies a controlling authority, and time metrics are defined for follow-up resolution by the deficient party.

### CROSS-REFERENCES TO RELATED APPLICATIONS

This application claims the benefit of U.S. Provisional Patent Application Ser. No. 61/768,622, filed Feb. 25, 2013, the entire content of which is herein incorporated by reference.

### STATEMENT REGARDING FEDERALLY SPONSORED RESEARCH OR DEVELOPMENT

NOT APPLICABLE

### BACKGROUND OF THE INVENTION

Physicians have a duty to heal patients and guide them through the health care system. Making the correct diagnosis and treatment is the basis of medicine, but enabling patients to receive their prescriptions, surgical procedures, therapy, or x-rays is a great challenge with our new healthcare system. Neither physicians nor patients have any effective means of reporting errors, omissions, or inefficiencies with the healthcare system, Pharmacy Benefits Managers (PBM), pharmacies, state insurance commissions, or federal agencies. Also, the public has no source to access reported errors, omissions, or inefficiencies reported by physicians and patients to evaluate health care plans. The physicians and patients are the only participants who can effectively change the systems through experiencing deficiencies.

### BRIEF SUMMARY OF THE INVENTION

Quality assurance reporting enables efficient and concise reports of errors, omissions, or deficiencies. It maintains a public record, establishes a communication platform for the public, physician, insurance company, state agencies, and federal agencies and establishes time metrics for corrective action. It also maintains anonymity of parties for patient and provider protection and assures dissemination of corrective actions and communication to deficient parties. The system may be a “cloud based” system where all parties can input information that is specific for a certain insurance company, PBM, state agency, or federal agency. By using the demographics in the system with automated letters to predetermined reporting agencies, the reporting process can be automated and metrics can be added for agency follow up. Through this process, the efficiency and documentation can be achieved to effectuate changes in our system.

In an exemplary embodiment, a computer-implemented method of reporting medical information for quality assurance includes the steps of (a) a computer server running a server program serving a web page accessible by parties associated with medical claims and procedures; (b) enabling the parties to report errors, omissions or deficiencies relating to the medical claims and procedures; (c) determining a deficient party based on the errors, omissions or deficiencies reported in step (b); (d) the computer server generating a report relating to the errors, omissions or deficiencies; (e) the computer server sending the report to the deficient party; (f) defining time metrics for the deficient party to respond to the report; (g) enabling the deficient party to respond to the report; and (h) when the deficient party responds to the report, communicating the response to the parties.

The parties associated with the medical claims and procedures may include physicians and patients and may include insurance companies, state agencies and federal agencies. Step (c) may be practiced by the parties identifying the deficient party. The method may further include publishing the report generated in step (d) on the web page. Prior to step (h), the method may further include the computer server receiving the deficient party response.

When the deficient party does not respond to the report, the computer server may notify an appropriate agency. Additionally, when the deficient party does not respond to the report, the computer server may publicize the lack of response.

In another exemplary embodiment, a computer-implemented method reports medical information for quality assurance. A computer server running a server program serves a web page that standardizes a format for parties to report deficiencies relating to medical claims and procedures. The computer server generates a deficiency report and delivers the deficiency report to a deficient party. The computer server publicizes the deficiency report and notifies a controlling authority, and time metrics are defined for follow-up resolution by the deficient party.

In yet another exemplary embodiment, a computer system for reporting medical information for quality assurance includes at least one user computer running a computer program that enables a user to report errors, omissions or deficiencies relating to medical claims and procedures, and a system server running a server program. The at least one user computer and the system server are interconnected by a computer network. The system server serves a web page accessible by the at least one user computer, where the server program is executed by the system server to generate a report relating to the errors, omissions or deficiencies and to send the report to a deficient party. The server program defines time metrics for the deficient party to respond to the report, and when the deficient party responds to the report, the system server communicates the response to the at least one user.

### BRIEF DESCRIPTION OF THE DRAWINGS

These and other aspects and advantages will be described in detail with reference to the accompanying drawings, in which:

FIG. 1 is a flow diagram of the reporting system; and

FIG. 2 is a detailed schematic of a computer system.

### DETAILED DESCRIPTION OF THE INVENTION

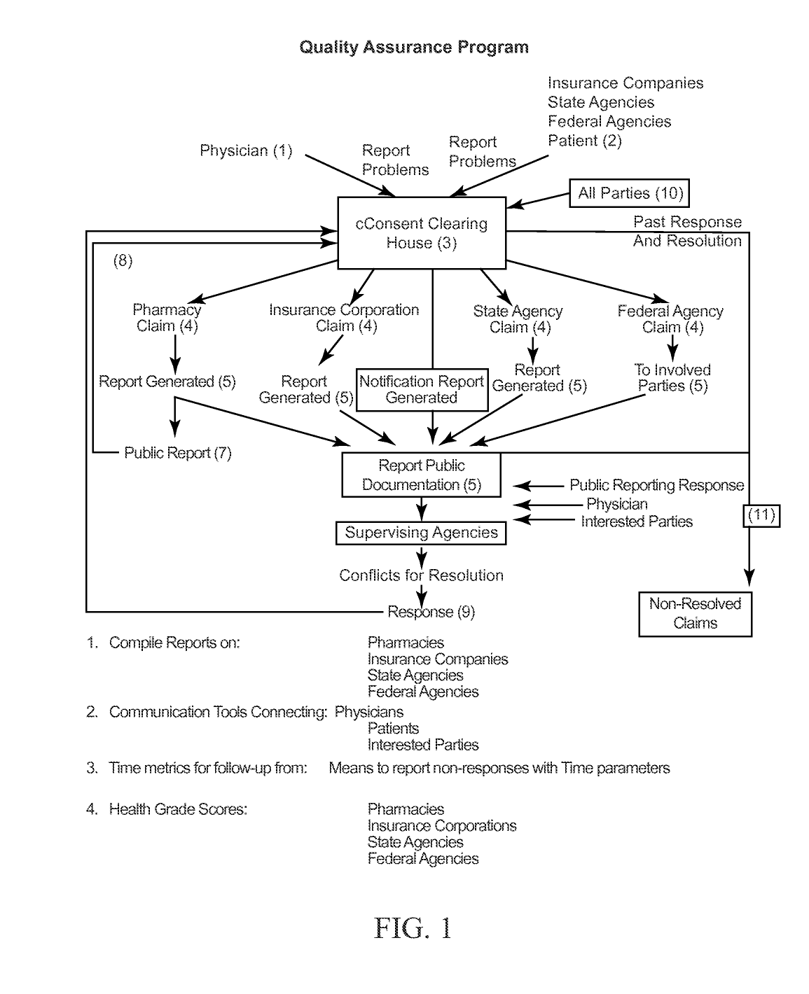

With reference to FIG. 1, the system provides for reporting medical information for quality assurance. A computer server runs a server program that serves a web page accessible by parties associated with medical claims and procedures. The parties may include physicians and patients (1), (2) as well as insurance companies, state agencies and federal agencies. The affected parties report errors, omissions or deficiencies relating to the medical claims and procedures to a system server (so called “cConsent Clearing House”) (3).

The system is used to process the organizational claims (4). The claim is organized into an official report (5) that is sent to the deficient party (6), publicly posted (7) and placed on a time metric Quality Assurance Module. The deficient parties respond (9) through the cConsent Clearing House, which then communicates with all involved parties (10). Claims not corrected by reported agencies are forwarded to the appropriate agencies and made public (11).

A challenge in our rapidly expanding technology is improving systems to the benefit of the patient. With a more complex integration, the minor errors or improvements that could occur may be overlooked unless there is an integrated clearing house assimilating data, transmitting information, and monitoring improvement. The system of the described embodiments improves communication between various parties in order to improve healthcare for the patient.

Parties who note deficiencies report their issues on the system. The process standardizes a format for reporting and enables communication through saved email contacts, delivers the deficiency reports to the appropriate parties, reports to controlling authorities, makes the information public and sets time metrics for follow up resolution from deficient parties.

The system enables the patient to navigate the reporting process, thereby increasing efficiency and delivery to specific agencies and maintains contact for follow up.

The quality assurance reporting process described with reference to FIG. 1 is preferably a browser-based system in which a program running on a user's computer (the user's web browser) requests information from a server program running on a system server. The system server sends the requested data back to the browser program, and the browser program then interprets and displays the data on the user's computer screen. The process is as follows:
1. The user runs a web browser program on his/her computer.
2. The user connects to the server computer (e.g., via the Internet). Connection to the server computer may be conditioned upon the correct entry of a password as is well known.
3. The user requests a page from the server computer. The user's browser sends a message to the server computer that includes the following:
   the transfer protocol (e.g., http://); and
   the address, or Uniform Resource Locator (URL).
4. The server computer receives the user's request and retrieves the requested page, which is composed, for example, in HTML (Hypertext Markup Language).
5. The server then transmits the requested page to the user's computer.
6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

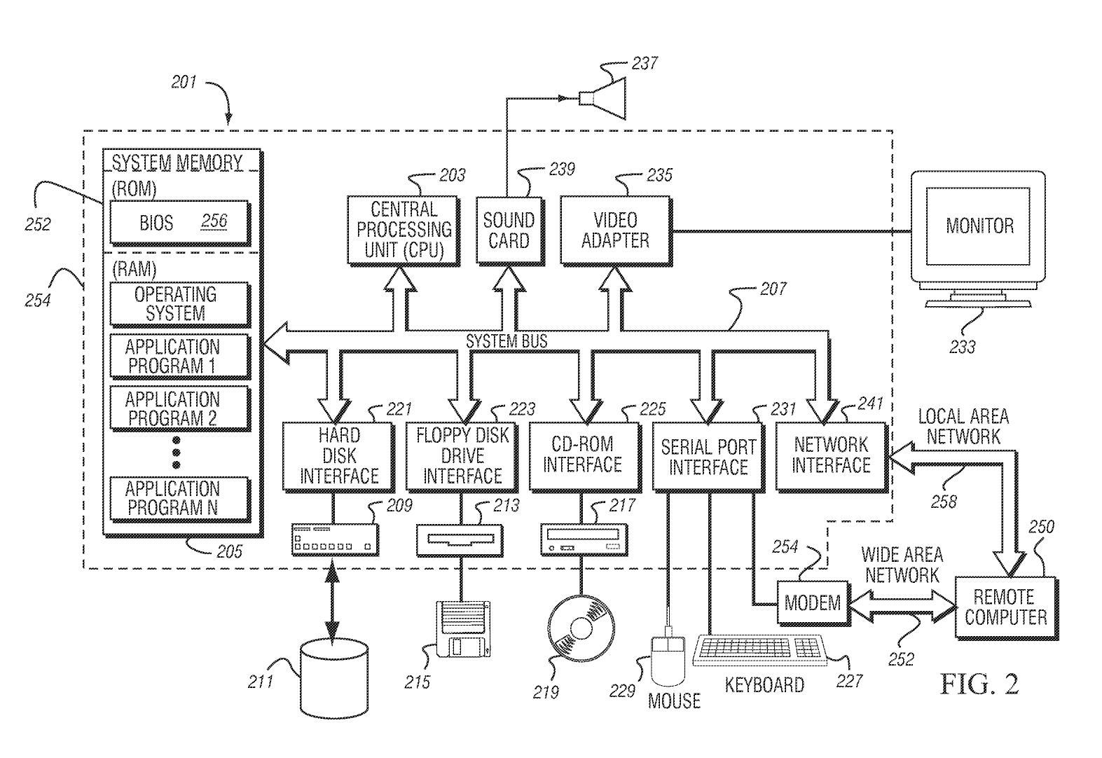

FIG. 2 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A computer-implemented method of reporting medical information for quality assurance, the method comprising:
(a) a computer server running a server program serving a web page accessible by parties associated with medical claims and procedures;
(b) enabling the parties to report errors, omissions or deficiencies relating to the medical claims and procedures;
(c) determining a deficient party based on the errors, omissions or deficiencies reported in step (b);
(d) the computer server generating a report relating to the errors, omissions or deficiencies;
(e) the computer server sending the report to the deficient party;
(f) defining time metrics for the deficient party to respond to the report;
(g) enabling the deficient party to respond to the report; and
(h) when the deficient party responds to the report, communicating the response to the parties.

2. A method according to claim 1, wherein the parties associated with the medical claims and procedures comprise physicians and patients.

3. A method according to claim 2, wherein the parties associated with the medical claims and procedures further comprise insurance companies, state agencies and federal agencies.

4. A method according to claim 1, wherein step (c) is practiced by the parties identifying the deficient party.

5. A method according to claim 1, further comprising publishing the report generated in step (d) on the web page.

6. A method according to claim 1, wherein prior to step (h), the method further comprises the computer server receiving the deficient party response.

7. A method according to claim 1, wherein when the deficient party does not respond to the report, the computer server notifying an appropriate agency.

8. A method according to claim 7, wherein when the deficient party does not respond to the report, the computer server publicizing a lack of response.

9. A computer-implemented method of reporting medical information for quality assurance, the method comprising:
(a) a computer server running a server program serving a web page that standardizes a format for parties to report deficiencies relating to medical claims and procedures;
(b) the computer server generating a deficiency report and delivering the deficiency report to a deficient party;
(c) the computer server publicizing the deficiency report and notifying a controlling authority; and
(d) defining time metrics for follow-up resolution by the deficient party.

10. A method according to claim 9, further comprising enabling the deficient party to respond to the report, and when the deficient party responds to the report, communicating the response to the parties.

11. A computer system for reporting medical information for quality assurance, the computer system comprising:
at least one user computer running a computer program that enables a user to report errors, omissions or deficiencies relating to medical claims and procedures; and
a system server running a server program, the at least one user computer and the system server being interconnected by a computer network, the system server serving a web page accessible by the at least one user computer, wherein the server program is executed by the system server to generate a report relating to the errors, omissions or deficiencies and to send the report to a deficient party, the server program defining time metrics for the deficient party to respond to the report, and when the deficient party responds to the report, the system server communicating the response to the at least one user.

12. A computer system according to claim 11, wherein the system server executes the server program to publish the report relating to the errors, omissions or deficiencies on the web page.

13. A computer system according to claim 11, wherein the computer program is executed by the at least one user computer to receive the deficient party response and communicate the deficient party response to the system server over the computer network.

14. A computer system according to claim 11, wherein when the deficient party does not respond to the report, the computer server executes the server program to notify an appropriate agency.

15. A computer system according to claim 14, wherein when the deficient party does not respond to the report, the computer server executes the server program to publicize a lack of response.
